(19) United States
(12) Patent Application Publication
(10) Pub. No.: US 2005/0239975 A1
(43) Pub. Date: Oct. 27, 2005

(54) Halogen free ignition resistant thermoplastic resin compositions

(76) Inventors: Joseph Gan, Bas-Rhin (FR); Bruce A. King, Midland, MI (US); Nicole H. Groot, Terneuzen (NL); Norbert L. Maeecker, Midland, MI (US); Sheila M. Tinetti, Midland, MI (US); William G. Stobby, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/514,603

(22) PCT Filed: Apr. 15, 2003
(86) PCT No.: PCT/US03/11822

§ 371 Date: Nov. 16, 2004

Related U.S. Application Data
(60) Provisional application No. 60/384,524, filed on May 30, 2002.

(51) Int. Cl. C08L 63/00

(52) U.S. Cl. 525/525

(57) ABSTRACT

The present invention is a halogen-free ignition resistant polymer composition comprising: A) a thermoplastic polymer, and B) a phosphorus element-containing epoxy resin.

### CROSS REFERENCE STATEMENT

This application claims the benefit of U.S. Provisional Application No. 60/384,524, filed May 30, 2002.

The present invention relates to thermoplastic polymer compositions which exhibit ignition resistance without the use of halogen containing compounds.

### BACKGROUND

Ignition resistant polymers have typically utilized halogen containing compounds to provide ignition resistance. However, there has been an increasing demand for halogen free compositions in ignition resistant polymer markets. Combinations of polyphenylene ether resins and triphenyl phosphine oxide have also been used as ignition resistant components as disclosed in Haaf et al, U.S. Pat. No. 4,107,232. However, such compositions have high viscosities due to the presence of high molecular weight polyphenylene ether resins, rendering it difficult to process through extrusion or injection molding equipment. WO 01/42359 discloses a flame retardant epoxy resin material of a non-halogenated phosphorus element-containing epoxy resin. However, these are thermoset compositions which cannot be used in injection molding applications.

Proposals have been made to use phosphorus-based flame retardants instead of halogenated fire retardants in epoxy resin formulations as described in, for example, EP A 0384939, EP A 0384940, EP A 0408990, DE A 4308184, DE A 4308185, DE A 4308187, WO A 96/07685, and WO A 96/07686. In these formulations a phosphorus flame retardant is pre-reacted with an epoxy resin to form a di- or multifunctional epoxy resin which is then cured with an amino cross-linker such as dicyandiamide, sulfanilamide, or some other nitrogen element-containing cross-linker to form a network. However, these compositions are again thermosets which cannot be used in injection molding applications.

WO 99/00451 discloses halogen free flame retardant epoxy resin compositions which utilize phosphonic acid esters. WO 99/00451 discloses the reaction of a phosphonic acid ester with an epoxy resin in the presence of a catalyst and a nitrogen-containing crosslinking agent. The epoxy resins described in WO 99/00451 have improved flame retardant properties at low levels of phosphonic acid ester flame retardant.

JP2001-49096 discloses a flame resistant resin composition of a polyester resin, a styrene resin, for example HIPS, and a flame retardant, for example phosphorus containing compound in combination with an aromatic epoxy resin. JP2000-239543 discloses a flame resistant resin composition, comprising a thermoplastic resin and a phosphorus-containing compound in combination with a polyarylate or aromatic epoxy resin. However, these compositions suffer from reduced heat resistance due to high phosphorus compound loading. In “Studies on the thermal stabilization enhancement of ABS; synergistic effect by triphenyl phosphate and epoxy resin mixtures” in Polymer 43(2002) 2249-2253, ABS compositions containing various epoxy resins with triphenylphosphate co-flame retardants are discussed. However, the phosphate flame retardants again tend to reduce the heat resistance of the composition.

Therefore, there remains a need to provide a thermoplastic polymer composition useful for injection molding applications, having good ignition resistance and heat resistance, without the use of halogen containing compounds.

### SUMMARY

The present invention relates to a halogen-free ignition resistant polymer composition comprising:
A) a thermoplastic polymer, and
B) a phosphorus element-containing epoxy resin.

Another embodiment of the present invention is a halogen-free ignition resistant polymer composition comprising:
A) 50-99 percent of a thermoplastic polymer,
B) 1-50 percent of a phosphorus element-containing epoxy resin, optionally
C) 0-20 percent of a phosphorus compound such as an aryl phosphate; and optionally
D) 0-30 percent of a polyphenylene ether polymer, such as polyphenylene oxide (PPO).

It has been discovered that certain phosphorus containing compounds can be reacted with epoxy oligomers to bond phosphorus to the epoxy backbone, allowing increased phosphorus content in a thermoplastic ignition resistant composition, without lowering the heat resistance of the composition.

### DETAILED DESCRIPTION OF INVENTION

Component (A) of the halogen-free ignition resistant polymer composition is a thermoplastic polymer. Typical thermoplastic polymers include, but are not limited to, polymers produced from vinyl aromatic monomers and hydrogenated versions thereof, including both diene and aromatic hydrogenated versions, such as styrene-butadiene block copolymers, polystyrene (including high impact polystyrene), acrylonitrile-butadiene-styrene (ABS) copolymers, and styrene-acrylonitrile copolymers (SAN); polycarbonate (PC), ABS/PC compositions, polyphenylene ether polymer (PPO), polyethylene terephthalate, epoxy resins, hydroxy phenoxy ether polymers (PHE) such as those taught in U.S. Pat. No. 5,275,853; U.S. Pat. No. 5,496,910; U.S. Pat. No. 3,305,528; which are incorporated herein by reference, ethylene vinyl alcohol copolymers, ethylene acrylic acid copolymers, polyolefin carbon monoxide interpolymers, polyolefins, cyclic olefin copolymers (COC's), other olefin copolymers (especially polyethylene copolymers) and homopolymers (for example, those made using conventional heterogeneous catalysts) and any combination thereof.

Thermoplastic polymers are well known by those skilled in the art, as well as methods for producing.

In one embodiment, the thermoplastic polymer is a rubber modified monovinylidene aromatic polymer produced by polymerizing a vinyl aromatic monomer in the presence of a dissolved elastomer or rubber. Vinyl aromatic monomers include, but are not limited to those described in U.S. Pat. No. 4,666,987, U.S. Pat. No. 4,572,819 and U.S. Pat. No. 4,585,825, which are herein incorporated by reference. Preferably, the monomer is of the formula: 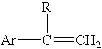
wherein R is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially paravinyltoluene, all isomers of ethyl styrene, propyl styrene, vinyl biphenyl, vinyl naphthalene, vinyl anthracene and the like, and mixtures thereof. The vinyl aromatic monomers may also be combined with other copolymerizable monomers. Examples of such monomers include, but are not limited to acrylic monomers such as acrylonitrile, methacrylonitrile, methacrylic acid, methyl methacrylate, acrylic acid, and methyl acrylate; maleimide, phenylmaleimide, and maleic anhydride.

The rubber used to produce the rubber modified monovinylidene aromatic polymer can be any rubber which will enhance the impact properties of the monovinylidene aromatic polymer, including any molecular architecture such as linear, branched, star branched, and homo- and copolymer diene rubbers, block rubbers, functionalized rubbers, low cis, high cis rubbers and mixtures thereof. The elastomer or rubber preferably employed are those polymers and copolymers which exhibit a second order transition temperature which is not higher than 0° C., preferably not higher than 20° C., and more preferably not higher than 40° C. as determined or approximated using conventional techniques, for example, ASTM test method D 52 T.

The rubber is typically used in amounts such that the rubber-reinforced polymer product contains from 3, preferably from 4, more preferably from 5 and most preferably from 6 to 20, preferably to 18 percent, more preferably to 16 and most preferably to 14 weight percent rubber, based on the total weight of the vinyl aromatic monomer and rubber components, expressed as rubber or rubber equivalent. The term “rubber” or “rubber equivalent” as used herein is intended to mean, for a rubber homopolymer, such as polybutadiene, simply the amount of rubber, and for a block copolymer, the amount of the copolymer made up from monomer which when homopolymerized forms a rubbery polymer, such as for a butadiene-styrene block copolymer, the amount of the butadiene component of the block copolymer.

The rubber is present as discrete rubber particles within the monovinylidene aromatic polymer matrix, and can have any type, including monomodal, bimodal or multimodal particle size distribution and particle size, as well as any morphology including cellular, core shell, onion-skin, and the like, as well as any combinations thereof.

Polymerization processes and process conditions for the polymerization of vinyl aromatic monomers, production of rubber modified polymers thereof and the conditions needed for producing the desired average particle sizes, are well known to one skilled in the art. Although any polymerization process can be used, typical processes are continuous bulk or solution polymerizations as described in U.S. Pat. No. 2,727,884 and U.S. Pat. No. 3,639,372, which are incorporated herein by reference. The polymerization of the vinyl aromatic monomer is conducted in the presence of predissolved elastomer to prepare impact modified, or grafted rubber containing products, examples of which are described in U.S. Pat. No. 3,123,655, U.S. Pat. No. 3,346,520, U.S. Pat. No. 3,639,522, and U.S. Pat. No. 4,409,369, which are incorporated by reference herein. The rubber is typically a butadiene or isoprene rubber, preferably polybutadiene. Preferably, the rubber modified vinyl aromatic polymer is high impact polystyrene (HIPS) or acrylonitrile-butadiene-styrene (ABS), with HIPS being most preferred.

The weight average molecular weight (Mw) of the thermoplastic polymer (A) can be any molecular weight which provides the desired Theological and mechanical properties for the application.

The thermoplastic polymer (A) is employed in the halogen-free ignition resistant polymer compositions of the present invention in amounts of at least about 30 parts by weight, preferably at least about 40 parts by weight, more preferably at least about 45 parts by weight, and most preferably at least about 50 parts by weight based on 100 parts by weight of the halogen-free ignition resistant polymer composition of the present invention. In general, the thermoplastic polymer component (A) is employed in amounts less than or equal to about 99 parts by weight, preferably less than or equal to about 95 parts by weight, more preferably less than or equal to about 90 parts by weight, and most preferably less than or equal to about 85 parts by weight based on 100 parts by weight of the halogen-free ignition resistant polymer composition of the present invention.

Component (B) in the halogen-free ignition resistant polymer composition of the present invention is a phosphorus element-containing epoxy resin, wherein phosphorus is bonded to the epoxy polymer backbone. The phosphorus element-containing epoxy resin can be produced by any method, but is typically obtained by either: reacting an epoxy resin with a phosphorus element-containing compound capable of reacting with an epoxy resin; or epoxidizing a phosphorus element-containing compound, such as a diol.

The phosphorus element containing-epoxy resin is a non-halogenated epoxy resin, or epoxy resin substantially free of halogen with some specific amount of phosphorus element contained therein. A resin which is “substantially free of halogen” means that the resin is completely free of halogen, that is 0 percent halogen, or that the resin contains some minor amount of halogen that does not affect the properties or performance of the resin, and is not detrimental to the resin. It is understood that in some epoxy resins there may be a very small amount of halogen impurities left from the production process. Typically, the amount of the phosphorus element in the epoxy resin is from 0.2 wt percent to 30 wt percent, preferably from 0.5 wt percent to 20 wt. percent, more preferably from 1.0 wt percent to 15 wt. percent, most preferably from 1.5 wt. percent to 10 wt. percent, based on the total weight of the epoxy resin. Generally, the phosphorus element-containing epoxy resin used in the present invention is a material derived from an epoxy resin which possesses, on average more than 1 and preferably at least 1.8, more preferably at least 2 epoxy groups per molecule. After the reaction of the phosphorus containing compound with the epoxy resin, the resultant product (the phosphorus element-containing epoxy resin) may contain as low as 0 wt. percent of residual epoxy groups, but can contain from 0 to 40, generally 1 to 40, typically 2 to 25, and more typically 3 to 20 wt. percent residual epoxy groups based on the total weight of the phosphorus element-containing epoxy resin. In the broadest aspect, the phosphorus element-containing epoxy resin material may be any phosphorus element-containing saturated or unsaturated aliphatic, cycloaliphatic, aromatic or heterocyclic compound which is derived from an epoxy resin having more than one 1,2-epoxy group.

In one embodiment, the phosphorus element-containing epoxy resin is selected from those described in U.S. Pat. No. 5,376,453; U.S. Pat. No. 5,405,931, and U.S. Pat. No. 6,291,627 B1, all of which are incorporated herein by reference, and WO 99/00451, including for example methyl diglycidyl phosphonate, ethyl diglycidyl phosphonate, propyl diglycidyl phosphonate, butyl diglycidyl phosphonate, vinyl diglycidyl phosphonate, phenyl diglycidyl phosphonate and biphenyl diglycidyl phosphonate; methyl diglycidyl phosphate, ethyl diglycidyl phosphate, n-propyl diglycidyl phosphate, n-butyl diglycidyl phosphate, isobutyl diglycidyl phosphate, allyl diglycidyl phosphate, phenyl diglycidyl phosphate, p-methoxyphenyl diglycidyl phosphate, p-ethoxyphenyl diglycidyl phosphate, p-propyloxyphenyl diglycidyl phosphate, p-isopropyloxyphenyl diglycidyl phosphate, phenylthiodiglycidyl phosphate, triglycidyl phosphate, tris(glycidylethyl)phosphate, p-glycidyl-phenyl ethyl glycidyl phosphate, benzyl diglycidyl thiophosphate, and combinations thereof.

Examples of a phosphorus element-containing epoxy resin useful in the present invention which is obtained by reacting an epoxy resin with a phosphorus element-containing compound capable of reacting with an epoxy resin include:
(a) The reaction product of: (i) an epoxy novolac, such as D.E.N.™ 438 or D.E.N.™ 439 which are trademarks of and commercially available from The Dow Chemical Company; a trisepoxy such as Tactix™ 742 (Trademark of Ciba Geigy); a dicyclopentadiene phenol epoxy novolac; or a glycidyl of tetraphenolethane, an epoxidized bisphenol-A novolac, an epoxidized cresol novolac, or other epoxy compounds such as diglycidyl ether of hydroquinone and others found in U.S. Pat. No. 5,405,931 and U.S. Pat. No. 6,291,627, herein incorporated by reference, and WO 99/00451, and (ii) a phosphorus element-containing compound reactive with the epoxy resin such as 9,10-dihydro-9-oxa-10-phospha-phenanthrene-10-oxide (DOP), such as “Sanko-HCA” which is commercially available from Sanko of Japan, or “Struktol Polydis PD 3710” which is commercially available from Schill-Seilacher of Germany; or
(b) the reaction product of: (i) an epoxy novolac, such as D.E.N.™ 438 or D.E.N.™ 439; a trisepoxy such as Tactix™ 742; an epoxidized bisphenol A novolac, a dicyclopentadiene phenol epoxy novolac; a glycidyl of tetraphenolethane; a diglycidyl ether of bisphenol-A; or a diglycidyl ether of bisphenol-F; diglycidyl ether of hydroquinone and (ii) a phosphorus element-containing compound selected from 10-(2′,5′-dihydroxyphenyl)-9,10-dihydro-9-oxa-10-phosphaphenanthrene-10-oxide (such as “Sanko HCA-HQ” which is commercially available from Sanko of Japan); bis(4-hydroxy-phenyl)phosphine oxide; tris(2-hydroxyphenyl-phosphine oxide; dimethyl-1-bis(4-hydroxyphenyl)-1-phenylmethylphonate; or tris(2-hydroxy-4/5-methylphenyl)phosphine oxide; or
(c) the reaction product of an epoxy resin and a phosphite; or
(d) the reaction product of an epoxy resin and a phosphinic acid; or
(e) The reaction product of an epoxy resin and phosphorus acid; or
(f) The reaction product of an epoxy resin and phosphoric acid; or
(g) The reaction product of an epoxy resin and a mixture of different phosphorus element containing compounds.

Examples of a phosphorus element-containing epoxy resin useful in the present invention which is obtained by epoxidizing a phosphorus element-containing compound include: the epoxidized product of a phosphorus element-containing compound such as 9,10-dihydro-9-oxa-10-phosphaphenanthrene-10-oxide (DOP); 10-(2′,5′-dihydroxyphenyl)-9,10-dihydro-9-oxa-10-phosphaphenanthrene-10-oxide (DOP-HQ); bis(4-hydroxyphenyl)-phosphine oxide; tris(2-hydroxyphenyl)phosphine oxide; dimethyl-1-bis(4-hydroxyphenyl)-1-phenylmethylphonate; tris(2-hydroxy-4/5-methylphenyl)phosphine oxide tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide; or mixtures thereof. The epoxidizing of the phosphorus element-containing compound is usually carried out with an epihalohydrin such as epichlorohydrin well known to those skilled in the art.

Phosphorus element-containing compounds or monomers used to modify epoxy resins are compounds containing reactive groups such as a phenolic group, an acid group, an amino group, an acid anhydride group, a phosphite group, or a phosphinate group which can react with the epoxy groups of the non-halogenated, non-phosphorus element-containing epoxy resin compound.

The phosphorus element-containing compound may contain on average, one or more than one functionality capable of reacting with the epoxy groups. Such phosphorus element-containing compound preferably contains on average 0.8 to 5, more preferably 0.9 to 4, and most preferably 1 to 3 functional groups capable of reacting with epoxy resin.

The phosphorus element-containing compounds include, for example one or more of the following compounds: P—H functional compounds such as for example 9,10-dihydro-9-oxa-10-phosphaphenanthrene-10-oxide (DOP), dimethylphosphite, diphenylphosphite, ethylphosphonic acid, diethylphosphinic acid, methyl ethylphosphinic acid, phenyl phosphonic acid, phenyl phosphinic acid, vinyl phosphoric acid, phenolic 10-(2′,5′-dihydroxyphenyl)-9,10-dihydro-9-oxa-10-phosphaphenanthrene-10-oxide (DOP-HQ) and the like; tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide; acid anhydride compounds such as M-acid-AH and the like; and amino functional compounds such for example bis(4-aminophenyl)phenylphosphate, and mixtures thereof. The chemical structure of some of the compounds described above are as follows: 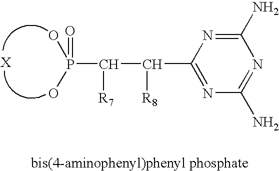
wherein X is CR³R⁴—(CR¹R²)—CR⁵R⁶ or o-phenylidene, n is 0 or 1 and R¹-R⁸ may be the same or different and represent H, CH₃, or C₂H₅;

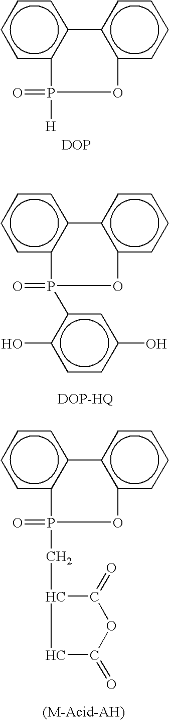

The phosphorus element-containing compounds may also include those compounds having epoxy groups such as those compounds described above for example those having the following structures: 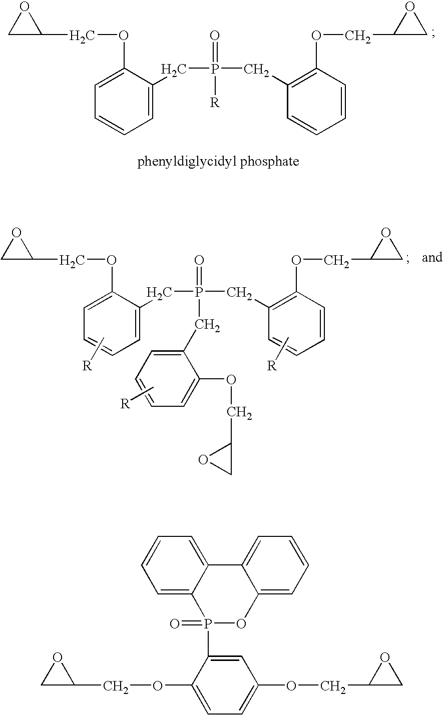
wherein R is independently a hydrogen or an alkyl group from C₁-C₁₀ such as methyl, ethyl, etc.

In one embodiment of the present invention, the phosphorus element-containing compound is for example, 9,10-dihydro-9-oxa-10-phosphaphenanthrene-10-oxide (DOP); 10-(2′,5′-dihydroxyphenyl)-9,10-dihydro-9-oxa-10-phosphaphenanthrene-10-oxide; bis(4-hydroxyphenyl)phosphine oxide; tris(2-hydroxyphenyl)phosphine oxide; dimethyl-1-bis(4-hydroxyphenyl)-1-phenylmethylphonate; tris(2-hydroxy-4/5-methylphenyl)phosphine oxide; tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide; or mixtures thereof.

Other phosphorus element-containing compounds, such as isomer mixtures of tris(2-hydroxyphenyl)phosphine oxides, are described in U.S. Pat. No. 6,403,220 and co-pending U.S. patent application Ser. No. 10/122,158, incorporated herein by reference.

The most preferred epoxy resins used to react with phosphorus element-containing compounds are epoxy novolac resins (sometimes referred to as epoxidized novolac resins, a term which is intended to embrace both epoxy phenol novolac resins and epoxy cresol novolac resins). Such epoxy novolac resin compounds have the following general chemical structural formula: 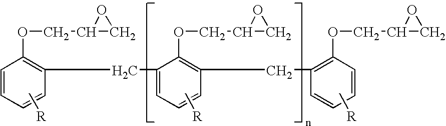
wherein “R” is hydrogen, C₁-C₃ alkylhydroxy or a C₁-C₃ alkyl, for example, methyl; and “n” is 0 or an integer from 1 to 10. “n” preferably has an average value of from 0 to 5.

Epoxy novolac resins (including epoxy cresol novolac resins) are readily commercially available, for example under the trade names D.E.N.™ (Trademark of The Dow Chemical Company), and Quatrex™ and tris epoxy such as Tactix™ 742 (Trademarks of Ciba). The materials of commerce generally comprise mixtures of various species of the above formula and a convenient way of characterizing such mixtures is by reference to the average, n′, of the values of n for the various species. Preferred epoxy novolac resins for use in accordance with the present invention are those in which n′ has a value of from about 2.05 to about 10, more preferably from about 2.5 to about 5.

The epoxidized bisphenol A novolacs include those polymers having the following structure, wherein GLY is a glycidyl group:

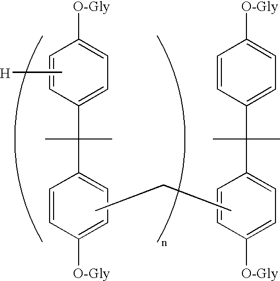

Trisepoxy resins include polymers having the structure:

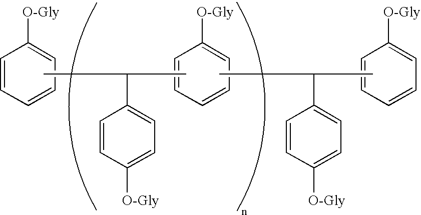

FIG. 2 tris phenol type epoxy

Other phosphorus element-containing epoxy resins include functionally modified phosphorus element-containing epoxy resins, wherein the residual epoxy groups of the epoxy resin are modified with an additional functionality. The additional functionality can be any functionality which will enhance the mechanical properties of the composition and is compatible with the thermoplastic resin. For thermoplastic resins such as monovinylidene aromatics and conjugated dienes, such functionalities might include, but not be limited to, butadienes, styrene-maleic anhydrides, methylene diphenyl diisocyanate, polybutadiene-maleic anhydride copolymers, carboxylic acid terminated butadienes, and carboxylic acid functionalized polystyrenes.

Typically, the weight average molecular weight (Mw) of the phosphorus element-containing epoxy resin is dependent upon the thermoplastic polymer used in the composition of the present invention and is generally from 300, preferably from 500, more preferably from 700 and most preferably from 800 to 100,000, generally to 50,000, typically to 25,000, preferably to 8,000, and more preferably to 5,000.

The amount of phosphorus element-containing epoxy resin in the halogen-free ignition resistant polymer composition of the present invention will depend upon the thermoplastic polymer used in the composition and is typically at least 1 wt. percent, generally at least 5 wt. percent, preferably at least 10 wt. percent, more preferably at least 15 wt. percent and most preferably at least 20 wt. percent and less than 50 wt. percent, preferably less than 45 wt. percent, more preferably less than 40 wt. percent and most preferably less than 35 wt. percent, based on the total weight of the halogen-free ignition resistant polymer composition.

In one embodiment, no additional phosphorus component is present in the halogen-free ignition resistant polymer composition of the present invention. In other words, the only phosphorus containing compound in the halogen-free ignition resistant polymer composition of the present invention is the phosphorus-containing epoxy resin.

Optionally, additional phosphorus element containing compounds can be added for additional ignition resistance. These compounds would be non-epoxy containing phosphorus element containing compounds. Suitable phosphorous compounds employed in the halogen-free ignition resistant polymer composition of the present invention as component (C) are organophosphorous compounds which include organophosphates, organophosphonites, organophosphonates, organophosphites, organophosphinites, organophosphinates, other phosphorus element-containing compounds such as 9,10-dihydro-9-oxa-10-phosphaphenanthrene-10-oxide (DOP); 10-(2′,5′-dihydroxyphenyl)-9,10-dihydro-9-oxa-10-phosphaphenanthrene-10-oxide (DOP-HQ); bis(4-hydroxyphenyl)-phosphine oxide; tris(2-hydroxyphenyl)phosphine oxide; dimethyl-1-bis(4-hydroxyphenyl)-1-phenylmethylphonate; tris(2-hydroxy-4/5-methylphenyl)phosphine oxide tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide; or mixtures thereof, as further described herein below.

Suitable organophosphorous compounds are disclosed, for example, in U.S. Patent Re. 36,188; U.S. Pat. No. 5,672,645; and U.S. Pat. No. 5,276,077, the teachings of which are incorporated by reference herein. A preferred organophosphorous compound is a monophosphorous compound represented by Formula I: 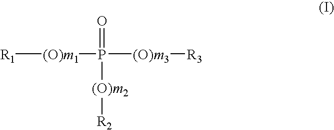
wherein R₁, R₂, and R₃, each represent an aryl or an alkaryl group chosen independently of each other and m1, m2, and m3 each independently of each other are 0 or 1.

Most preferred monophosphorus compounds are monophosphates where m1, m2, and m3 are all 1 and R₁, R₂, and R₃ are independently methyl, phenyl, cresyl, xylyl, cumyl, naphthyl, for example, trimethyl phosphate, triphenyl phosphate, all isomers of tricresyl phosphate and mixtures thereof, especially tri(4-methylphenyl)phosphate, all isomers of trixylyl phosphate and mixtures thereof, especially tri(2,6-dimethylphenyl)phosphate, tricresyl phosphate, all isomers of tricumyl phosphate and mixtures thereof, and trinaphthyl phosphate, or mixtures thereof.

Another preferred organophosphorous compound is an multiphosphorous compound represented by Formula II: 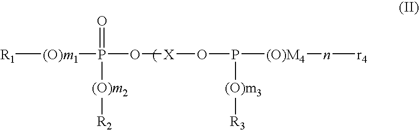
wherein R₁, R₂, R₃, and R₄ each represent an aryl or an alkaryl group chosen independently of each other, X is an arylene group derived from a dihydric compound, m1, m2, m3, and m4 each independently of each other are 0 or 1 and n has an average value greater than 0 and less than 10, when n is equal to or greater than 1. These multiphosphorous compounds are sometimes referred to as oligomeric phosphorous compounds.

Preferred multiphosphorous compounds are multiphosphates where m1, m2, m3, and m4 are 1, R₁, R₂, R₃, and R₄ are independently methyl, phenyl, cresyl, xylyl, cumyl, naphthyl, X is an arylene group derived from a dihydric compound, for example, resorcinol, hydroquinone, bisphenol A, and n has an average value greater than 0 and less than about 5, preferably n has an average value greater than about 1 and less than about 5. For example preferred oligomeric phosphates having an n value between about 1 and about 2 are m-phenylene-bis(diphenylphosphate), p-phenylene-bis(diphenylphosphate), m-phenylene-bis(dicresylphosphate), p-phenylene-bis(dicresylphosphate), m-phenylene-bis(dixylylphosphate), p-phenylene-bis(dixylylphosphate), Bisphenol-A-bis(diphenylphosphate), Bisphenol A-bis(dicresylphosphate), Bisphenol A-bis(dixylylphosphate), or mixtures thereof.

The phosphorous compound component (C) is optionally employed in the halogen-free ignition resistant polymer compositions of the present invention in amounts of from 0 to 25 by weight, based on 100 parts by weight of the halogen-free ignition resistant polymer composition of the present invention, typically from about 3 to about 30 weight percent, and more preferably 5 to about 20 weight percent, based on the total weight of the halogen-free ignition resistant polymer composition.

Optionally, in one embodiment the halogen-free ignition resistant polymer composition of the present invention additionally comprises a polyphenylene ether, Component (D). Polyphenylene ethers are made by a variety of catalytic and non-catalytic processes from the corresponding phenols or reactive derivatives thereof. By way of illustration, certain of the polyphenylene ethers are disclosed in U.S. Pat. No. 3,306,874 and U.S. Pat. No. 3,306,875, and in Stamatoff, U.S. Pat. No. 3,257,357 and U.S. Pat. No. 3,257,358, incorporated herein by reference. In the Hay patents, the polyphenylene ethers are prepared by an oxidative coupling reaction comprising passing an oxygen-containing gas through a reaction solution of a phenol and a metal-amine complex catalyst. Other disclosures relating to processes for preparing polyphenylene ether resins, including graft copolymers of polyphenylene ethers with styrene type compounds, are found in Fox, U.S. Pat. No. 3,356,761; Sumitomo, U.K. Pat. No. 1,291,609; Bussink et al., U.S. Pat. No. 3,337,499; Blanchard et al., U.S. Pat. No. 3,219,626; Laakso et al, U.S. Pat. No. 3,342,892; Borman, U.S. Pat. No. 3,344,166; Hori et al., U.S. Pat. No. 3,384,619; Faurote et al., U.S. Pat. No. 3,440,217; and disclosures relating to metal based catalysts which do not include amines, are known from patents such as Wieden et al., U.S. Pat. No. 3,442,885 (copper-amidines); Nakashio et al., U.S. Pat. No. 3,573,257 (Metalalcoholate or—phenolate); Kobayashi et al., U.S. Pat. No. 3,455,880 (cobalt chelates); and the like. In the Stamatoff patents, the polyphenylene ethers are produced by reacting the corresponding phenolate ion with an initiator, such as peroxy acid salt, an acid peroxide, a hypohalite, and the like, in the presence of a complexing agent Disclosures relating to non-catalytic processes, such as oxidation with lead dioxide, silver oxide, etc., are described in Price et al., U.S. Pat. No. 3,382,212. Cizek, U.S. Pat. No. 3,383,435 discloses polyphenylene ether-styrene resin compositions. All of the above-mentioned U.S. patents are incorporated herein by reference.

The polyphenylene ether resins are preferably of the type having the repeating structural formula: 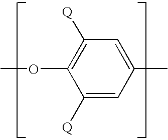
wherein the oxygen ether atom of one unit is connected to the benzene nucleus of the next adjoining unit, n is a positive integer and is at least 50, and each Q is a mono-valent substituent selected from the group consisting of hydrogen, halogen, hydrocarbon radicals free of a tertiary alpha carbon atom, halohydrocarbon radicals having at least two carbon atoms between the halogen atom and the phenyl nucleus, hydrocarbonoxy radicals and halohydrocarbonoxy radicals having at least two carbon atoms. The preferred polyphenylene ether resin is poly(2,6-dimethyl-1,4-phenylene)ether resin.

The polyphenylene ether resin, when included, is employed in the halogen-free ignition resistant polymer compositions of the present invention in amounts of at least about 1 part by weight, preferably at least about 3 parts by weight, more preferably at least about 5 parts by weight, and most preferably at least about 8 parts by weight to about 35 parts by weight, preferably to about 30 parts by weight, more preferably to about 25 parts by weight, and most preferably to about 20 parts by weight based on 100 parts by weight of the halogen-free ignition resistant polymer composition of the present invention.

In addition, the halogen-free ignition resistant polymer composition may also optionally contain one or more additives that are commonly used in polymers of this type. Preferred additives of this type include, but are not limited to: antioxidants; impact modifiers, such as styrene-butadiene rubbers; plasticizers, such as mineral oil; antistats; flow enhancers; mold releases; pigments; wetting agents; fluorescent additives; fillers, such as calcium carbonate, calcium hydroxide, magnesium hydroxide, talc, clay, mica, wollastonite, hollow glass beads, titanium oxide, silica, carbon black, glass fiber, potassium titanate, single layers of a cation exchanging layered silicate material or mixtures thereof, and perfluoroalkane oligomers and polymers (such as polytetrafluoroethylene) for improved drip performance in UL 94, halogen-free physical and chemical blowing agents including carbon dioxide. Further, compounds which stabilize ignition resistant polymer compositions against degradation caused by, but not limited to heat, light, and oxygen, or a mixture thereof may be used. Although small amounts of halogen containing additives can be used, it is preferred that the composition be halogen free, wherein the composition does not contain any halogen at levels above 0.1 weight percent, based on the total weight of the composition.

If used, the amount of such additives will vary and need to be controlled depending upon the particular need of a given end-use application, which can easily and appropriately exercised by those skilled in the art.

Preparation of the halogen-free ignition resistant polymer composition of the present invention can be accomplished by any suitable mixing means known in the art, including dry blending the individual components and subsequently melt nixing, either directly in the extruder used to make the finished article or pre-mixing in a separate extruder. Dry blends of the compositions can also be directly injection molded without pre-melt mixing.

The halogen-free ignition resistant polymer compositions of the present invention, and polymers comprised therein, are thermoplastic polymers. When softened or melted by the application of heat, the halogen-free ignition resistant polymer composition of this invention can be formed or molded using conventional techniques such as compression molding, injection molding, gas assisted injection molding, calendering, vacuum forming, thermoforming, extrusion and/or blow molding, alone or in combination. The halogen-free ignition resistant polymer composition can also be formed, spun, or drawn into films, fibers, multi-layer laminates or extruded sheets, or can be compounded with one or more organic or inorganic substances, on any machine suitable for such purpose.

In one embodiment, the composition of the present invention can be utilized in the preparation of a foam. The halogen-free ignition resistant polymer composition is extruded into foam by melt processing it with a blowing agent to form a foamable mixture, extruding said foamable mixture through an extrusion die to a region of reduced pressure and allowing the foamable mixture to expand and cool. Conventional foam extrusion equipment, such as screw extruders, twin screw extruders and accumulating extrusion apparatus can be used. Suitable processes for making extruded foams from resin/blowing agent mixtures are described in U.S. Pat. No. 2,409,910; U.S. Pat. No. 2,515,250; U.S. Pat. No. 2,669,751; U.S. Pat. No. 2,848,428; U.S. Pat. No. 2,928,130; U.S. Pat. No. 3,121,130; U.S. Pat. No. 3,121,911; U.S. Pat. No. 3,770,688; U.S. Pat. No. 3,815,674; U.S. Pat. No. 3,960,792; U.S. Pat. No. 3,966,381; U.S. Pat. No. 4,085,073; U.S. Pat. No. 4,146,563; U.S. Pat. No. 4,229,396; U.S. Pat. No. 4,302,910; U.S. Pat. No. 4,421,866; U.S. Pat. No. 4,438,224; U.S. Pat. No. 4,454,086 and U.S. Pat. No. 4,486,550, incorporated herein by reference.

The blowing agent is preferably a halogen-free physical or chemical blowing agent and may be incorporated or mixed into the polymer material by any convenient means. Most typically, a physical blowing agent is fed under pressure into the barrel of an extruder where it mixes with the molten polymer. However, such mixing may be accomplished by a variety of other means including so-called static mixers or interfacial surface generators such as are described in U.S. Pat. No. 3,751,377 and U.S. Pat. No. 3,817,669. Chemical blowing agents can be mixed with the polymer beforehand or fed into the extruder together with the polymer. The polymer/blowing agent mixture is then heated to a temperature above the boiling (in the case of a physical blowing agent) or decomposition (in the case of a chemical blowing agent) temperature of the blowing agent, under sufficient pressure that the resulting foamable mixture does not expand until it is forced through the extrusion die. Typically, the foamable mixture is cooled in the extruder, other mixing device or in a separate heat exchanger to a foaming temperature that permits the formation of a foam having the desired density and desired cell size to an optimum foaming temperature. The foamable mixture is then passed through the die into an area of reduced pressure and temperature zone where the foam expands and cools to form a cellular structure.

The foam can be extruded into any variety of shapes, but will most commonly be extruded to form sheet (nominal thickness of 13 mm or less) or plank (nominal thickness over 13 mm) products. Sheet products are conveniently made using a circular die, producing a tubular foam that is slit to form a flat sheet. Plank products are conveniently made using a rectangular or “dog-bone” die.

Suitable physical blowing agents include carbon dioxide, nitrogen, lower alkanols, alkyl ethers, water, and/or hydrocarbons, especially alkanes having up to six carbon atoms. Hydrocarbon blowing agents include methane, ethane, propane, n-butane, isobutane, n-pentane, isopentane, neopentane, cyclobutane and cyclopentane. Alcohols include methanol, ethanol, n-propanol and isopropanol. Suitable alkyl ethers include dimethyl ether, diethyl ether and methyl ethyl_ether. Mixtures of two or more of these physical blowing agents can be used.

Suitable chemical blowing agents include azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-initrosoterephthalamide, trihydrazino triazine and sodium bicarbonate.

Although the present invention relates to a halogen-free ignition resistant composition, it should be noted that halogenated blowing agents would also perform adequately in order to produce a foam. However, preferably, a non-halogenated blowing agent is employed.

In one embodiment, a blowing agent mixture of a non-halogenated blowing agent mixture comprising a lower alcohol having from 1 to 4 carbon atoms, alkyl ether, alkyl ester, hydrocarbons, water (up to 50 percent) and carbon dioxide is used.

Various auxiliary materials can be used in the foaming process. Common such auxiliary materials include cell control agents (nucleators), cell enlarging agents, stability control agents (permeability modifiers), antistatic agents, crosslinkers, processing aids (such as slip agents), stabilizers, flame retardants, ultraviolet absorbers, acid scavengers, dispersion aids, extrusion aids, antioxidants, colorants, inorganic fillers and the like. Cell control agents and stability control agents are preferred.

Preferred cell control agents include finely divided inorganic substances such as calcium carbonate, calcium silicate, indigo, talc, clay, titanium dioxide, silica, calcium stearate or diatomaceous earth, as well as small amounts of chemicals that react under extrusion conditions to form a gas, such as a mixture of citric acid or sodium citrate and sodium bicarbonate. The amount of nucleating agent employed may range from about 0.01 to about 5 parts by weight per hundred parts by weight of a polymer resin. The preferred range is from 0.1 to about 3 parts by weight.

When the foam is to be used as thermal insulation, additives that attenuate the infrared transmission through the foam structure can be incorporated to augment its insulation performance, even when the blowing agent includes an insulating gas. Examples of IR attenuators include carbon black materials, graphite, titanium dioxide, aluminum particles, and the like. When IR attenuators are used, a reduced proportion of an insulating blowing agent can be used.

The foam may be subjected to various subsequent processing steps if desired. It is often desired to cure the foam (that is, replace the blowing agent in the cells with air). Process steps intended to reduce the curing time include perforation, as described in U.S. Pat. No. 5,424,016, heating the foam at slightly elevated (100-130° F.) temperatures for a period of days to weeks, or combinations thereof. In addition, the foam may be crushed in order to open cells. Crosslinking steps may also be performed.

In one embodiment, the present invention is a halogen-free ignition resistant polymer composition consisting essentially of:

A) a thermoplastic polymer, and B) a phosphorus element-containing epoxy resin.

In another embodiment, the present invention is a halogen-free ignition resistant polymer composition consisting essentially of:

A) 50-99 percent of a thermoplastic polymer;
B) 1-50 percent of phosphorus element-containing epoxy resin.
C) 0-25 percent of a phosphorus compound such as an aryl phosphate;
D) 0-35 percent of a polyphenylene ether polymer, such as polyphenylene oxide (PPO).

The phrase “consisting essentially of” means that the listed components are essential, although other materials can be present in minor amounts which do not significantly alter the properties or purpose of the present composition. In a preferred embodiment, other polymeric materials will not be present in amounts which would substantially alter the properties of the halogen-free ignition resistant polymer composition. Typically, other polymeric materials will not be more than 10 weight percent, preferably not more than 8 weight percent, more preferably not more than 5 weight percent and most preferably not more than 3 weight percent of the total halogen-free ignition resistant polymer composition.

The halogen-free ignition resistant polymer compositions of the present invention are useful to fabricate numerous useful articles and parts. Some of the articles which are particularly well suited include television cabinets, computer monitors, related printer housings which typically requires to have excellent flammability ratings. Other applications include automotive and small appliances. The following examples are provided to illustrate the present invention. The examples are not intended to limit the scope of the present invention and they should not be so interpreted. Amounts are in weight parts or weight percentages unless otherwise indicated.

Flammability ratings are obtained by testing under UL-94 vertical (V) or UL-94 horizontal (HB) flammability test. For the vertical burning test, five test specimens, of a desired thickness measuring 12.5 millimeter (mm) by 125 mm, suspended vertically over surgical cotton are ignited by a 18.75 mm Bunsen burner flame; two ignitions of 10 seconds each are applied to the samples. The rating criteria include the sum of after-flame times after each ignition, glow time after the second ignition, and whether the bar drips flaming particles that ignite the cotton.

Production Procedure for Phosphorus Containing Epoxy Resins (P-Epoxy)

The phosphorus containing epoxy resins are general prepared in a 1L glass reactor or 10 liter stainless steel reactor, equipped with a mechanical stirrer, a heating jacket, fitted with a N2 inlet and a condenser. The corresponding amount of DEN 438 and approximately 20-30 percent of the total amount of DOP (depending on the total amount of DOP to be added to the reaction mixture) are charged to the reactor and heated to 110° C. 1000 ppm of triphenylethylphosphonium acetate catalyst based on total solid components is added to the resin and heated up to 130° C. and the reaction temperature is controlled below 185° C. The rest of DOP is added into the reaction mixture portion by portion so that the temperature of the reaction mixture can be controlled below 185° C. After all of the DOP is added, the temperature of the reaction mixture is held for approximately 30 min at 185° C. and the product is flaked as a solid.

### EXAMPLE I AND COMPARATIVE EXAMPLE I

A composition of high impact polystyrene (HIPS, Mw 142,000, rubber content 8.5 percent, bimodal distribution (0.8 and 6 microns), 1 percent mineral oil), triphenyl phosphate (TPP), and P-Epoxy (Dow Epoxy Novolak DEN™ 438 (46 wt. percent)+9,10-dihydro-9-oxa-10-phosphaphenanthrene-10-oxide (DOP), 54 wt. percent) is melt blended and injection molded.

TABLE I

| | Example I | Comparative Example I |
|---|---|---|
| Wt. percent HIPS | 87 | 96 |
| Wt. percent TPP | 3 | 4 |
| Wt. percent P-Epoxy | 10 | 0 |
| Melt Flow Rate (g/10 min) | 39.0 | 16.3 |
| UL Rating 2.5 mm | V-2 | NR |

Addition of P-Epoxy gives unexpectedly high melt flow rate, and also produces a V-2 flammability rating. The blend without P-Epoxy burns to the clamp and is not rated (NR).

### EXAMPLE II AND COMPARATIVE EXAMPLE II

HIPS/P-Epoxy/High MW Epoxy

Blends of HIPS (Mw 142,000, rubber content 8.5 percent, bimodal distribution (0.8 and 6 microns), 1 percent mineral oil) with P-Epoxy (Dow Epoxy Novolak DEN™ 438 (46 wt. percent)+9,10-dihydro-9-oxa-10-phosphaphenanthrene-10-oxide (DOP) 54 percent) and additional thermoplastic polymer, hydroxy-phenoxyether polymer (PHE) are melt blended and injection molded.

TABLE II

| | Example II | Comparative Example II |
|---|---|---|
| Percent HIPS | 50 | 60 |
| Percent TPP | 0 | 10 |
| Percent P-Epoxy | 20 | 0 |
| Percent PHE | 30 | 30 |
| Vicat (° C.) | 98 | 79 |
| Melt Flow Rate (g/10 min) | 46 | 31 |
| Extinguish in Vertical Burn | Yes | No |
| Extinguish in Horizontal Burn | Yes | No |

Addition of P-Epoxy gives unexpectedly high melt flow rate, has a good heat resistance, and also extinguishes in vertical and horizontal burning. The blend without P-Epoxy burns to the clamp and is not rated (NR).

### EXAMPLE III AND COMPARATIVE EXAMPLE III

HIPS/PPO/P-Epoxy/Phosphate

Blends of HIPS (Mw of 150,000, 9 percent rubber, bimodal distribution of 1 and 5 microns, 1.5 percent mineral oil.), PPO, Phosphate (TPP) and P-Epoxy (Dow Epoxy

Novolak DEN™ 438 (46 wt. percent)+9,10-dihydro-9-oxa-10-phosphaphenanthrene-10-oxide (DOP) 54 percent) are melt blended and injection molded.

TABLE III

| | Example III | Comparative Example III |
|---|---|---|
| Percent HIPS | 75 | 80 |
| Percent TPP | 10 | 10 |
| Percent P-Epoxy | 5 | 0 |
| Percent PPO | 10 | 10 |
| Melt Flow Rate (g/10 min) | 15 | 13 |
| UL Rating 2.5 mm | V-2 | V-2 |
| Extinguish in Horizontal Burn | Yes | No |

Addition of P-Epoxy gives higher melt flow rate, and extinguishes in horizontal burning. The blend without P-Epoxy burns to the clamp in horizontal burning.

### EXAMPLES IV AND COMPARATIVE EXAMPLE IV

HIPS/PPO/P-Epoxy/Phosphate

Blends of HIPS (10 percent rubber, no mineral oil, and 2 micron particle size); P-Epoxy (produced by reacting 22 percent DOP and 78 percent DEN 438); resorcinol diphenyl diphosphate (RDP) and polyphenylene oxide (PPO) are melt blended and injection molded.

TABLE IV

| | Example IV | Comparative Example IV |
|---|---|---|
| Percent HIPS | 53 | 52 |
| Percent PPO | 24 | 30 |
| Percent P-Epoxy | 7 | 0 |
| Percent RDP | 16 | 18 |
| Melt Flow Rate (g/10 min) | 16.6 | 3.5 |
| UL Rating 2.5 mm | V-0 | V-2 |

Addition of P-Epoxy gives higher melt flow rate, and a V-0 flammability rating. The blend without P-Epoxy has only V-2 rating.

### EXAMPLES V AND VI AND CONTROL EXAMPLE V

Production of (P-Epoxy) with Phosphorus Acid (DEN™ 438/DOP/Phosphorus acid (51.2/47.3/1.5))

The phosphorus containing epoxy resins are general prepared in a 10 liter stainless steel reactor, equipped with a mechanical stirrer, a heating jacket, fitted with a N2 inlet and a condenser. The corresponding amount of DEN™ 438 and approximately 20-30% of the total amount of DOP are charged to the reactor and heated to 110° C. 1000 ppm of triphenylethylphosphonium acetate/acetic acid catalyst based on total solid components is added to the resin and heated up to 130° C. and the reaction temperature is controlled below 185° C. The rest of DOP is added into the reaction mixture portion by portion so that the temperature of the reaction mixture can be controlled below 185° C. After all of the DOP is added, the temperature of the reaction mixture is held for approximately 30 min at 185° C. and sample is taken for epoxy content measurement The corresponding amount of phosphorus acid is added to the reaction product and the temperature increased to 192° C. After 30 min, the final product is flaked as solid.

Production of Polystyrene Foam Structures

Polystyrene foam structures of the present invention are made with an apparatus comprised of a 1.0 inch (25 mm) single-screw extruder, a mixer, a cooler, and a die in sequence. The polystyrene feedstock and additive concentrates are dry blended and fed into the extruder at a total rate of 2.3 kilograms per hour (5 pounds per hour). The blowing agent (3.5 pph carbon dioxide) is injected into the polymer melt in the mixer to form a foamable gel. The foamable gel is cooled and conveyed through a 1/8 inch wide slit die into a region of lower pressure to form the foam structure.

The polystyrene feedstock employed is a granular polystyrene with a weight average molecular weight of about 168,000 according to size exclusion chromatography. The additive concentrate utilized in the preparation of Example V consists of 15% P-epoxy and 7.5% triphenylphosphate (TPP). Two additive concentrates are utilized in the preparation of Example VI: 1) 25.5% PPO/8.5% TPP, and 2) 25% P-epoxy. The polystyrene resin of the preparation of the additive concentrates is a granular polystyrene with a weight average molecular weight of about 180,000 according to size exclusion chromatography. The P-epoxy in Examples V and VI consists of: Dow Epoxy Novolak DEN™ (51.2 wt. %)+9,10-dihydro-9-oxa-10-phosphaphenanthrene-10-oxide (47.3) (DOP)+phosphorus acid (1.5%) as taught above.

The extruder zones are maintained at the following set point temperatures: feeding zone=105° C., melting zone=140° C., metering zone=175° C., and mixing zone=180° C. The cooling zone temperatures and die block temperatures are adjusted so that the gel can be cooled to a uniform temperature for optimum foam expansion.

Flammability Testing of Polystyrene Foam Structures

The foam samples are aged for two weeks prior to flammability testing. The flammability properties of the foam structures of the present invention are determined by: a modified laboratory version of the ASTM E-84 tunnel test, the limiting oxygen index test (LOI), and a cone calorimeter. The modified E-84 test is designed to determine the rate of burning per inch of sample, as well as the total extinguish time. In this test a natural gas or propane flame is positioned under one end of a horizontally positioned sample of plastic foam for 1.5 seconds. The sample measures 6 inches (15.2 cm) by ¼-inch (0.6 cm), by 1-inch (2.54 cm). A timer is activated when a burner flame is withdrawn and the burn time in seconds per inch is recorded, as well as the total burn time when the flame extinguishes. The average test time of 5 samples is given. The limiting oxygen index (LOI) of the foam samples is measured according to ASTM D 2863-97. Cone calorimeter testing is carried out according to ASTM E-1354-99 (heat flux=35 kW/m²); an average of 3 samples is given. Table V illustrates the polymeric foam compositions together with the foam flammability results. The table shows that Examples V and VI have a slower and shorter burning time relative to Control Example V, as well as higher LOI values. The cone calorimetry data also shows that Examples V and VI have lower peak heat release rates, increased ignition times, and a greater percentage of char relative to Control Example V.

TABLE V
CO₂-Blown Foams

| | Control | Example | |
|---|---|---|---|
| | Example V | V | Example VI |
| % Total Polystyrene | 100 | 85 | 70 |
| % P-epoxy | 0 | 10 | 10 |
| % TPP | 0 | 5 | 5 |
| % PPO | 0 | 0 | 15 |
| Modified ASTM E-84 test data | | | |
| Burn time (sec) at | | | |
| 1 inch (2.5 cm) | 4.0 | 6 | 3 |
| 2 inch (5.1 cm) | 12.0 | 0 | 0 |
| 3 inch (7.6 cm) | 21.0 | 0 | 0 |
| 4 inch (10.2 cm) | 28.0 | 0 | 0 |
| 5 inch (12.7 cm) | 35.0 | 0 | 0 |
| Total time until | 37.0 | 11 | 10 |
| extinguishment | | | |
| Limiting Oxygen Index | 20 | 22 | 24 |
| Cone calorimeter data | | | |
| peak heat release rate (kW/m2) | 429 | 362 | 241 |
| time to ignition (sec) | 72 | 76 | 101 |
| % char remaining after | 0 | 2 | 13 |
| extinguishme [symbol] | | | |

1. A halogen-free ignition resistant polymer composition comprising:
A) a thermoplastic polymer, and
B) a phosphorus element-containing epoxy resin.

2. The halogen-free ignition resistant polymer composition of claim 1, wherein A) is selected from the group consisting of: polymers produced from a vinyl aromatic monomer or hydrogenated versions thereof, polycarbonate (PC), ABS/PC compositions, hydroxy phenoxy ether polymers, polyphenylene ether polymers, polyethylene terephthalate, epoxy resins, ethylene vinyl alcohol copolymers, ethylene acrylic acid copolymers, polyolefin carbon monoxide interpolymers, polyolefins, cyclic olefin copolymers (COC's), olefin copolymers and homopolymers and any combination thereof.

3. The halogen-free ignition resistant polymer composition of claim 2, wherein A) is selected from the group consisting of: styrene-butadiene block copolymers, polystyrene, high impact polystyrene, acrylonitrile-butadiene-styrene (ABS) copolymers, and styrene-acrylonitrile copolymers (SAN).

4. The halogen-free ignition resistant polymer composition of claim 1, wherein A) is from 50 to 99 wt. percent and B) is from 1 to 50 wt. percent of the total weight of the halogen-free ignition resistant polymer composition.

5. The halogen-free ignition resistant polymer composition of claim 1 wherein B) is produced by 1) reacting an epoxy resin with a phosphorus element-containing compound capable of reacting with an epoxy resin; or 2) epoxidizing a phosphorus element-containing compound.

6. The halogen-free ignition resistant polymer composition of claim 1 wherein the amount of phosphorus element in the phosphorus element containing epoxy resin is from 0.2 wt. percent to 30 wt. percent, based on the total weight of the epoxy resin.

7. The halogen-free ignition resistant polymer composition of claim 1 wherein the phosphorus element-containing epoxy resin is a material produced from an epoxy resin which possesses, on average more than 1 epoxy group per molecule.

8. The halogen-free ignition resistant polymer composition of claim 1 wherein the phosphorus element-containing epoxy resin is selected from the group comprising methyl diglycidyl phosphonate, ethyl diglycidyl phosphonate, propyl diglycidyl phosphonate, butyl diglycidyl phosphonate, vinyl diglycidyl phosphonate, phenyl diglycidyl phosphonate and biphenyl diglycidyl phosphonate; methyl diglycidyl phosphate, ethyl diglycidyl phosphate, n-propyl diglycidyl phosphate, n-butyl diglycidyl phosphate, isobutyl diglycidyl phosphate, allyl diglycidyl phosphate, phenyl diglycidyl phosphate, p methoxyphenyl diglycidyl phosphate, p-ethoxyphenyl diglycidyl phosphate, p-propyloxyphenyl diglycidyl phosphate, p-isopropyloxyphenyl diglycidyl phosphate, phenylthiodiglycidyl phosphate, triglycidyl phosphate, tris(glycidylethyl)phosphate, p-glycidyl-phenyl ethyl glycidyl phosphate, benzyl diglycidyl thiophosphate, and combinations thereof.

9. The halogen-free ignition resistant polymer composition of claim 5 wherein the phosphorus element-containing epoxy is:
(a) The reaction product of: (i) an epoxy novolac, a trisepoxy, a dicyclopentadiene phenol epoxy novolac, a glycidyl of tetraphenolethane, an epoxidized bisphenol-A novolac, an epoxidized cresol novolac and (ii) 9,10-dihydro-9-oxa-10-phosphaphenanthrene-10-oxide, or
(b) the reaction product of: (i) an epoxy novolac, a trisepoxy, an epoxidized bisphenol A novolac, a dicyclopentadiene phenol epoxy novolac, a glycidyl of tetraphenolethane, a diglycidyl ether of bisphenol-A, diglycidyl ether of hydroquinone, or a diglycidyl ether of bisphenol-F and (ii) a phosphorus element-containing compound selected from 10-(2′,5′-dihydroxyphenyl)-9,10-dihydro-9-oxa-10-phosphaphenanthrene-10-oxide, bis(4-hydroxy-phenyl)phosphine oxide; tris(2-hydroxyphenyl-phosphine oxide; dimethyl-1-bis(4-hydroxyphenyl)-1-phenylmethylphonate; or tris(2-hydroxy-4/5-methylphenyl)phosphine oxide; or
(c) the reaction product of an epoxy resin and a phosphite; or
(d) the reaction product of an epoxy resin and a phosphinic acid; or
(e) the reaction product of an epoxy resin and phosphorus acid; or
(f) the reaction product of an epoxy resin and phosphoric acid; or
(g) the reaction product of an epoxy resin and a mixture of different phosphorus element containing compounds.

10. The halogen-free ignition resistant polymer composition of claim 5 wherein the phosphorus element-containing epoxy resin is the epoxidized product of 9,10-dihydro-9-oxa-10-phosphaphenanthrene-10-oxide, 10-(2′,5′-dihydroxyphenyl)-9,10-dihydro-9-oxa-10-phosphaphenanthrene-10-oxide, bis(4-hydroxyphenyl)-phosphine oxide, tris(2-hydroxyphenyl)phosphine oxide, dimethyl-1-bis(4-hydroxyphenyl)-1-phenylmethylphonate, tris(2-hydroxy-4/5-methylphenyl)phosphine oxide tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide, or mixtures thereof.

11. The halogen-free ignition resistant polymer composition of claim 1 wherein the phosphorus element-containing epoxy resin is selected from those having the following structures: 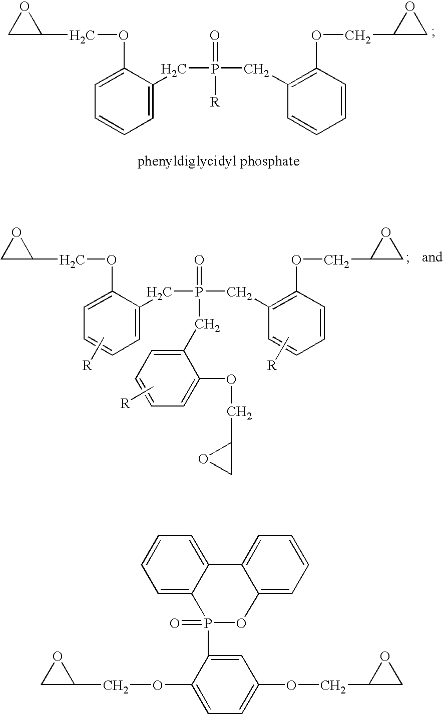
wherein R is independently a hydrogen or an alkyl group from C₁-C₁₀.

12. The halogen-free ignition resistant polymer composition of claim 1 wherein the phosphorus element-containing epoxy resin is a functionally modified phosphorus element-containing epoxy resin, modified with an additional functionality selected from butadienes, styrene-maleic anhydrides, methylene diphenyl diisocyanate, polybutadiene-maleic anhydride copolymers, carboxylic acid terminated butadienes, and carboxylic acid functionalized polystyrenes.

13. The halogen-free ignition resistant polymer composition of claim 1, additionally comprising a polyphenylene ether.

14. The halogen-free ignition resistant polymer composition of claim 1, additionally comprising a non-epoxy phosphorus element containing compound.

15. The halogen-free ignition resistant polymer composition of claim 1 consisting essentially of:
A) 50-99 percent of a thermoplastic polymer,
B) 1-50 percent of a phosphorus element-containing epoxy resin,
C) 0-25 percent of a phosphorus compound, and
D) 0-35 percent of a polyphenylene ether polymer.

16. A foam produced from the halogen-free ignition resistant polymer composition of claim 1.

17. An article produced from the halogen-free ignition resistant polymer composition of claim 1.
